(19) United States
(12) Patent Application Publication
(10) Pub. No.: US 2022/0025836 A1
(43) Pub. Date: Jan. 27, 2022

(54) FUEL SUPPLY DEVICE

(71) Applicant: Andreas Stihl AG & Co. KG, Waiblingen (DE)

(72) Inventors: Michael Grether, Waiblingen (DE); Bernd Engel, Stuttgart (DE)

(21) Appl. No.: 17/380,800

(22) Filed: Jul. 20, 2021

(30) Foreign Application Priority Data
Jul. 21, 2020 (EP) 20 186 991.4

(51) Int. Cl. F02M 1/02; F02M 7/18; F02M 19/08; F02M 11/06

(52) U.S. Cl. CPC F02M 1/02; F02M 11/06; F02M 19/081; F02M 7/18

(57) ABSTRACT

A fuel supply device has a base body, in which an intake channel section is formed. At least one adjustable throttle element for controlling the free flow cross section of the intake channel section is provided. At least one fuel opening opens into the intake channel section. A partition wall section is arranged in the intake channel section upstream of the throttle element. The partition wall section and the throttle element divide, in a completely open position of the throttle element, the intake channel section upstream of the throttle element into a mixture channel, into which the fuel opening feeds fuel, and an air channel. In order to improve the cooling of the fuel supply device, the partition wall section has at least one element for increasing the surface area within the mixture channel.

### CROSS REFERENCE TO RELATED APPLICATION

This application claims priority of European patent application no. 20 186 991.4, filed Jul. 21, 2020, the entire content of which is incorporated herein by reference.

### TECHNICAL FIELD

The disclosure relates to a fuel supply device and to a fuel supply device.

### BACKGROUND

U.S. Pat. No. 7,258,327 has disclosed a fuel supply device, namely a carburetor which has an adjustable throttle element. A partition wall section is arranged in the intake channel section of the fuel supply device upstream of the throttle element, the partition wall section and the throttle element dividing, in a completely open position, the intake channel section into a mixture channel and an air channel. In a completely open position, the throttle element bears against the partition wall section, which results in a separation of the air channel and the mixture channel.

Fuel supply devices of this type are usually used to feed fuel to an internal combustion engine, in particular a two-stroke engine. It is to be prevented during operation that vapor bubbles which can impair correct metering of the fuel to be fed are formed in the fuel supply device. To this end, the fuel supply device is to be cooled in a suitable manner during operation.

### SUMMARY

It is an object of the invention to provide a fuel supply device, by way of which effective cooling of the fuel supply device is achieved during operation.

The object can, for example, be achieved by way of a fuel supply device including: a base body defining an intake channel section therein; an adjustable throttle element configured to control a free flow cross section of the intake channel section; a fuel opening which opens into the intake channel section; a partition wall section arranged in the intake channel section upstream of the throttle element; the partition wall section and the throttle element dividing, in a completely open position of the throttle element, the intake channel section upstream of the throttle element into a mixture channel, into which the fuel opening opens for feeding fuel, and an air channel, wherein the throttle element bears against the partition wall section in the completely open position; and, the partition wall section has an element for increasing a surface area within the mixture channel.

The object can, for example, also be achieved by way of a fuel supply device including: a base body defining an intake channel section therein; at least one adjustable throttle element configured to control a free flow cross section of the intake channel section; a fuel opening which opens into the intake channel section; a partition wall section arranged in the intake channel section upstream of the throttle element; the partition wall section and the throttle element dividing, in a completely open position of the throttle element, the intake channel section upstream of the throttle element into a mixture channel, into which the fuel opening opens for feeding fuel, and an air channel; the partition wall section being configured in one piece with the base body; and, the partition wall section having an element for increasing a surface area within the mixture channel.

According to an aspect of the disclosure, the partition wall section has at least one element for increasing the surface area within the mixture channel. It has been shown that the evaporation enthalpy which is required for the evaporation of the fuel which is fed into the intake channel contributes significantly to the cooling of the fuel supply device. The disclosure then provides for the surface area within the mixture channel to be increased by way of at least one element for increasing the surface area, and thus for a higher degree of evaporation in the intake channel section in the fuel supply device and, as a result, an improved cooling action to be achieved.

Here, precisely one element for increasing the surface area can be provided, or a plurality of elements for increasing the surface area, in particular a multiplicity of elements for increasing the surface area, can be provided.

Here, an increase in the surface area is advantageously considered in a cross section perpendicularly with respect to the longitudinal center axis. The increase in the surface area is an increase in the surface area in a cross section perpendicularly with respect to the longitudinal center axis with respect to a straight, planar course of the partition wall, in particular, through the thinnest point of the partition wall in this cross section.

The circumferential length is advantageously increased in a cross section, in which the surface area is increased, by at least 20% with respect to a straight, planar course of the partition wall section through the thinnest point of the partition wall section in this cross section. The increase in the surface area is, in particular, in relation to a straight, planar course of the partition wall section through the point of the partition wall section which has the smallest thickness and/or the smallest spacing from the air channel in this cross section.

According to an embodiment, it is provided that the partition wall section is configured in one piece with the base body of the fuel supply device. As a result, the base body can be cooled particularly effectively via the partition wall section. As an alternative, it can be provided that the partition wall section and the base body are of separate configuration. The base body and a partition wall section which is configured separately from the base body are advantageously connected by means of a pressed joint.

The throttle element advantageously bears against the partition wall section in a completely open position. The throttle element is preferably a throttle valve. It can also be provided, however, that the throttle element is of roller-shaped configuration.

The element for increasing the surface area is preferably configured in one piece with the partition wall section. This results in satisfactory thermal conduction between the at least one element for increasing the surface area and the partition wall section. If the partition wall section is configured in one piece with the base body, the heat can be transferred satisfactorily from the at least one element for increasing the surface area into the base body of the fuel supply device, and the base body can thus be cooled effectively.

The base body of the fuel supply device advantageously consists of aluminum or an aluminum alloy. In one preferred configuration, the base body and the partition wall section consist of aluminum or of an aluminum alloy.

The intake channel section is preferably separated completely, with consideration of manufacturing tolerances, into an air channel and a mixture channel. The partition wall section preferably adjoins the throttle element over at least 60%, in particular at least 70%, preferably at least 90% of the width of the intake channel section in a completely open position of the throttle element. Here, the width of the intake channel section is measured on the throttle element. An opening is advantageously formed between the partition wall section and the throttle element in a partially and/or completely closed position of the throttle element, which opening connects the air channel and the mixture channel to one another. As a result, fuel/air mixture can pass out of the mixture channel into the air channel and can be fed via the air channel to the internal combustion engine during idling or partial load operation. As a result, excessive starvation at low rotational speeds can be avoided.

The element for increasing the surface area advantageously brings about an increase in the circumferential length, that is, that length of the boundary walls of the mixture channel which is measured in a plane perpendicularly with respect to the longitudinal center axis of the intake channel section. The element for increasing the surface area preferably increases the circumferential length of the mixture channel with respect to a mixture channel with a planar partition wall section which runs parallel to the longitudinal center axis of the intake channel section.

The at least one element for increasing the surface area is preferably oriented in the longitudinal direction of the intake channel section. Disadvantageous influencing of the flow in the intake channel section by way of the at least one element for increasing the surface area can be largely avoided as a result.

A plurality of elements for increasing the surface area are preferably provided which are arranged in the transverse direction of the intake channel section at a spacing from one another on the partition wall section. The spacing between adjacent elements for increasing the surface area is preferably approximately from 50% to 200% of the width of an element for increasing the surface area. At least one element for increasing the surface area is particularly preferably a rib. Another configuration of the at least one element for increasing the surface area, for example a mound-shaped configuration or the like, can also be advantageous, however. The height of the at least one element for increasing the surface area is preferably less than 20%, in particular less than 10% of the diameter of the intake channel section at the choke shaft. The width in the transverse direction of the intake channel section of the at least one element for increasing the surface area, in particular of the at least one rib, can be constant here over the length of the element or can vary over the length of the element. It is particularly preferably provided that the width of the at least one element for increasing the surface area increases in the flow direction toward the internal combustion engine. The width and the height of the at least one element for increasing the surface area advantageously increase in the same direction, in particular in the flow direction toward the internal combustion engine. Easy demolding, in particular in the case of the rib being molded on the base body of the carburetor, is possible as a result of the increase of the width and the height.

In order to achieve a satisfactory discharge of the heat which is produced during operation from the fuel system of the fuel supply device, it is particularly preferably provided that the partition wall section is configured from metal. The partition wall section is advantageously configured in one piece on the base body of the fuel supply device, in particular is cast from metal in one piece on the latter. This results in simplified production of the fuel supply device. The base body also preferably consists of metal.

In order to achieve a satisfactory intake and evaporation of fuel in the mixture channel, a Venturi section is advantageously configured in the fuel supply device. Particularly preferably, the Venturi section is configured in the mixture channel on the partition wall section. A simple configuration is achieved if that section of the intake channel wall which lies opposite the partition wall section has no Venturi section or only a Venturi section of small configuration in the mixture channel.

The Venturi section is preferably formed by way of at least one element for increasing the surface area, in particular by way of at least one rib. Here, the rib can have a length in the flow direction which is greater than the greatest width of the rib. A smaller length of the rib in the flow direction can also be advantageous, however. The rib can be, in particular, of pin-shaped configuration. Other elements for increasing the surface area, for example a lattice structure or the like, can be advantageous.

An adjustable choke element is advantageously arranged in the intake channel section upstream of the throttle element. The partition wall section is advantageously arranged in the flow direction between a choke shaft of the choke element and a throttle shaft of the throttle element. In a completely open position, the choke element preferably bears against the partition wall section. Both the throttle element and the choke element particularly preferably bear against the partition wall section in a completely open position. As a result, a substantial, in particular complete separation of the air channel and the mixture channel in the intake channel section is achieved by way of the throttle element, the choke element and the partition wall section in the case of full load. This results in lower exhaust gas emissions values for a two-stroke engine which is operated by way of the fuel supply device.

In order to achieve a high air throughput during operation, the at least one element for increasing the surface area is preferably arranged in such a way that it is arranged in the flow direction toward the internal combustion engine behind the choke shaft or a fastening element for fastening the choke element to the choke shaft. The at least one element for increasing the surface area, in particular all the elements for increasing the surface area, are/is preferably covered completely by a choke shaft and a fastening element for fastening the choke element to the choke shaft, in the case of a completely open choke element and in the case of a viewing direction in the direction of the longitudinal center axis from the choke element to the throttle element. Accordingly, the choke element is not visible behind the choke shaft and the fastening element in this viewing direction.

The at least one element for increasing the surface area preferably extends over a large part of the spacing between the throttle element and the choke shaft. The length, measured in the direction of the longitudinal center axis of the intake channel section, of at least one element for increasing the surface area is advantageously from 70% to 100% of the spacing of the throttle element from the choke shaft at this point in the case of a completely open throttle element. As a result of the comparatively great length of the at least one element for increasing the surface area, a satisfactory cooling action can be achieved via the at least one element for increasing the surface area.

The control of the fuel quantity which is fed via the fuel opening into the mixture channel can take place electronically, for example via an electromagnetic valve. As an alternative, the fuel quantity can also be controlled mechanically, for example in a manner which is dependent on the pressure in a regulating chamber, which pressure is advantageously set via a regulating diaphragm.

The fuel is injected, in particular, into the mixture channel. Here, the fuel pressure is higher than the pressure in the mixture channel. It is preferably provided that the fuel is injected in the direction of the partition wall section, advantageously directly onto the partition wall section. It can also be provided, however, that the fuel is sucked into the mixture channel on account of the negative pressure which prevails in the mixture channel.

### BRIEF DESCRIPTION OF THE DRAWINGS

The invention will now be described with reference to the drawings wherein:

FIG. 1 shows a diagrammatic sectional illustration of a two-stroke engine with a fuel supply device which is arranged on it, the throttle element and the choke element being completely open;

FIG. 2 shows a section through the fuel supply device of the two-stroke engine from FIG. 1;

FIG. 3 shows a section along the line III-III in FIG. 2;

FIGS. 4 and 5 show details of perspective sectional illustrations of the two-stroke engine from FIG. 1 in the region of the fuel supply device;

FIG. 6 shows a perspective sectional illustration through the fuel supply device;

FIG. 7 shows a perspective sectional illustration through the two-stroke engine in the region of the fuel supply device, the throttle element and the choke element being completely closed;

FIG. 8 shows a section along the line VIII-VIII in FIG. 2;

FIG. 9 shows details of a sectional illustration through a further embodiment of a fuel supply device;

FIG. 10 shows an enlarged illustration of details of the partition wall section of the fuel supply device from FIG. 9; and,

FIGS. 11 to 12 show enlarged illustrations of details of partition wall sections of further embodiments of the fuel supply device.

### DESCRIPTION OF THE PREFERRED EMBODIMENTS

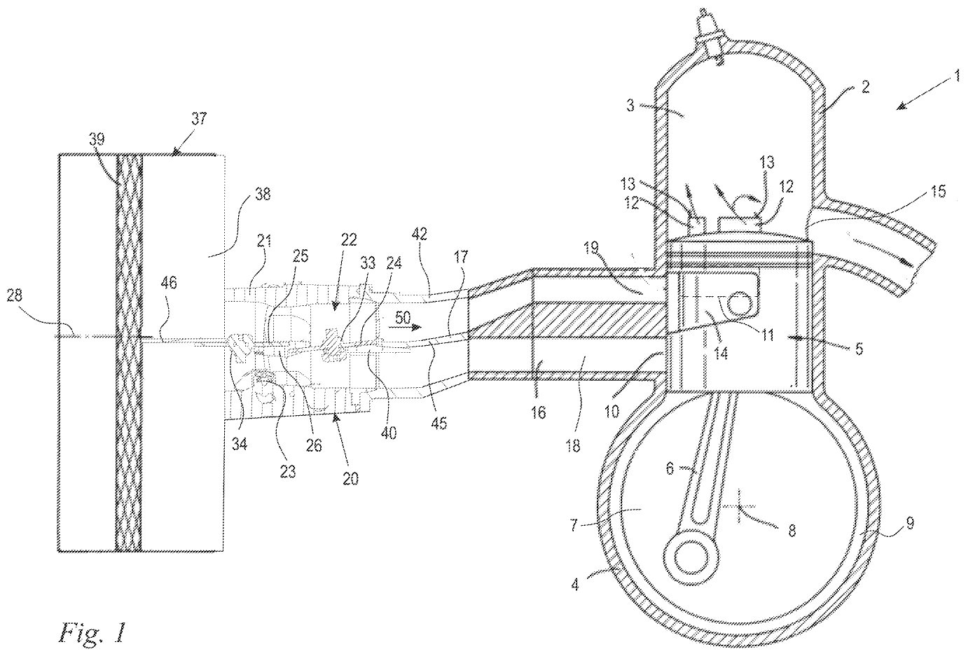

FIG. 1 diagrammatically shows a two-stroke engine 1. In the embodiment, the two-stroke engine 1 is a single cylinder engine. The two-stroke engine 1 is a two-stroke engine which operates with stratified scavenging. The two-stroke engine 1 has a cylinder 2, in which a combustion chamber 3 is configured. The combustion chamber 3 is delimited by a piston 5 which is mounted so as to move to and fro in the cylinder 2. The piston 5 drives, via a connecting rod 6, a crankshaft 7 which is mounted in a crankcase 4 such that it can be rotated about a rotational axis 8.

In an alternative embodiment, a four-stroke engine, in particular a mixture-lubricated four-stroke engine, can be provided instead of the two-stroke engine 1.

The two-stroke engine 1 sucks in fuel/air mixture and air via an air filter 37 during operation. The air filter 37 has filter material 39 which separates the surrounding area from a clean space 38 of the air filter 37. An intake channel 16 of the two-stroke engine 1 opens into the clean space 38. In the embodiment, the intake channel 16 is separated into a mixture channel 18 and an air channel 19 via a partition wall 17 as far as into the clean space 38 of the air filter 37. A fuel supply device 20 is provided for the feed of fuel, in which fuel supply device 20 an intake channel section 22 of the intake channel 16 is configured. In the embodiment, the fuel supply device 20 is a carburetor. The fuel supply device 20 has a base body 21. A throttle element 24 and a choke element 25 are mounted pivotably in the base body 21. In the embodiment, the throttle element 24 and the choke element 25 are configured as flaps. It can be provided in an alternative configuration that the throttle element 24 and/or the choke element 25 are/is of roller-shaped configuration.

In the fuel supply device 20, a fuel opening 23 opens into the mixture channel 18. The mixture channel 18 opens by way of a mixture inlet 10 on the cylinder bore of the cylinder 2. The mixture inlet 18 is controlled by the piston 5. The mixture inlet 18 is open toward a crankcase interior 9 of the crankcase 4 in the region of the top dead center of the piston 5. As shown in FIG. 1, the mixture inlet 10 is closed toward the crankcase interior 9 in the region of the bottom dead center.

The air channel 19 opens by way of at least one air inlet 11 on the cylinder bore. The air inlet 11 is also controlled by the piston 5. The piston 5 advantageously has at least one piston pocket 14 which connects the air inlet 11 in the region of the top dead center of the piston 5 to at least one transfer window 13 of a transfer channel 12. The transfer channels 12 connect the crankcase interior 9 fluidically to the combustion chamber 3 when the transfer windows 13 are open. In the embodiment, two transfer channels 12 with in each case one transfer window 13 are provided on each side of the sectional plane from FIG. 1, which transfer channels 12 are connected via a piston pocket 14 to an air inlet 11. An outlet 15 which is likewise controlled by the piston 5 leads from the combustion chamber 3.

The throttle element 24 is mounted pivotably by way of a throttle shaft 33. The choke element 25 is mounted pivotably by way of a choke shaft 34. A partition wall section 26 is arranged in the intake channel section 22 in a flow direction 50 between the choke shaft 34 and the throttle shaft 33, which partition wall section 26 forms a section of the partition wall 17 and separates the air channel 19 and the mixture channel 18 from one another.

A partition wall section 46 can advantageously be provided upstream of the throttle shaft 34, which partition wall section 46 forms a further section of the partition wall 17. The partition wall section 46 can be configured in one piece with the housing of the air filter 37 or can be configured separately from the housing of the air filter 37.

A partition wall section 40 is provided downstream of the throttle shaft 33, which partition wall section 40 forms a further section of the partition wall 17 and is held on the base body 21. A connecting piece 42 extends between the fuel supply device 20 and the cylinder 2. The connecting piece 42 can be, for example, an elastic connecting piece. A partition wall section 45 is configured on the connecting piece 42, which partition wall section 45 separates the air channel 19 and mixture channel 18 from one another and forms a section of the partition wall 17. As FIG. 1 also shows, the partition wall 17 extends approximately in the direction of a longitudinal center axis 28 of the intake channel section 22. During operation, air and mixture flow from the air filter 37 to the cylinder 2 in a flow direction 50.

During operation of the two-stroke engine 1, fuel/air mixture is sucked into the crankcase interior 9 during the upward stroke of the piston 5, as soon as the mixture inlet 10 is opened by the piston 5. As soon as the piston pocket 14 connects the air inlet 11 to the at least one transfer window 13, largely fuel-free air is sucked into the transfer channels 12 and is pre-stored therein. During the downward stroke of the piston 5, the mixture in the crankcase interior 9 is compressed. As soon as the transfer windows 13 are opened by the downward moving piston 5, fuel-free air which is pre-stored in the transfer channels 12 flows first of all into the combustion chamber 3 and flushes exhaust gases through the outlet 15. Subsequently, fresh mixture flows in from the crankcase interior 9 into the combustion chamber 3. During the following upward stroke of the piston 5, the mixture in the combustion chamber 3 is compressed and is ignited by a sparkplug 32 in the region of the top dead center of the piston 5. The combustion which thereupon takes place accelerates the piston 5 in the direction of the crankcase interior 9. As soon as the outlet 15 is opened by the piston 5, the exhaust gases flow out through the outlet 5 and are flushed out of the transfer channels 12 by the air which flows in through the transfer windows 13.

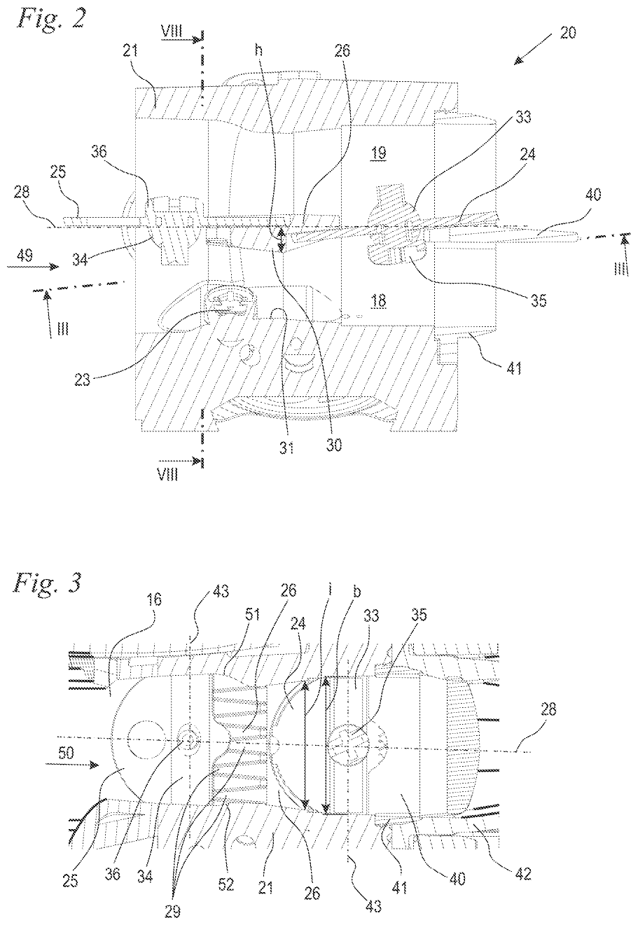

FIG. 2 shows the fuel supply device 20 in detail. The throttle element 24 is fixed on the throttle shaft 33 by way of a fastening element 35. The choke element 25 is fixed on the choke shaft 34 by way of a fastening element 36. In the embodiment, the fastening elements 35 and 36 are fastening screws. As FIG. 2 shows, a holding ring 41 is fixed on the base body 21. The holding ring 41 is preferably pressed into the base body 21 on the downstream side of the base body 21. The partition wall section 40 is advantageously configured on the holding ring 41. The holding ring 41 and the partition wall section 40 are preferably configured in one piece with one another. FIG. 2 shows the throttle element 24 and the choke element 25 in a completely open position. This arrangement corresponds to the arrangement in the case of full load of the two-stroke engine 1. The throttle element 24 and the choke element 25 preferably bear against the partition wall section 26.

In an alternative advantageous configuration, it can be provided that the throttle element 24 and/or the choke element 25 do/does not bear against the partition wall section 26 in a completely open position. In this case, the completely open position of the throttle element 24 and/or the choke element 25 can be defined by way of a stop which is arranged at another location. The throttle element 24 advantageously bears against the partition wall section 40. As an alternative, it can be provided that the throttle element 24 does not bear against the partition wall section 40.

The partition wall section 26 is preferably of thickened configuration on the side which lies opposite the fuel opening 23. The partition wall section 26 forms a Venturi section 30.

In the region, in which the choke element 25 bears against the partition wall section 26, the partition wall section 26 has a maximum height h on the side which delimits the mixture channel 18. The height h is selected in such a way that the partition wall section 26 is preferably arranged, in a viewing direction 49 from the choke shaft 34 to the throttle shaft 33, completely behind the choke shaft 34 or the fastening element 36, by way of which the choke element 25 is fastened to the choke shaft 34. The partition wall section 26 is covered by the choke shaft 34 and the fastening element 36. That section of the intake channel wall 31 which lies opposite the partition wall section 26 or the Venturi section 30 on the partition wall section 26 preferably does not have a Venturi section.

In an advantageous alternative configuration, that section of the intake channel wall 31 which lies opposite the partition wall section 26 or the Venturi section 30 on the partition wall section 26 has a Venturi section of only small configuration or of complete configuration. Here, a Venturi section of small configuration is a Venturi section, on which the flow cross section is decreased less than in the case of a carburetor, on which the partition wall section 26 does not support a Venturi section 30.

As FIG. 3 shows, in particular, the partition wall section 26 supports a plurality of (in the embodiment, five) ribs 29. The ribs 29 are configured as a thickened portion of the partition wall section 26. In the embodiment, the ribs 29 form the Venturi section 30. The ribs 29 are oriented with their longitudinal direction parallel to the longitudinal center axis 28 of the intake channel section 22. As FIG. 3 shows, the partition wall section 26 extends from a first longitudinal wall 51 of the intake channel section 22 to an opposite second longitudinal wall 52. Accordingly, in a region upstream of the throttle element 24, the partition wall section 26 extends over the entire width of the intake channel section 22. Upstream of the throttle shaft 33, the intake channel 16 widens. The width i of the partition wall section 26 on its downstream side is slightly smaller than the width b, measured on the central axis 43 of the throttle shaft 33, of the intake channel section 22. Therefore, in a completely open position of the throttle element 24, the partition wall section 26 does not adjoin the throttle element 24 over the entire width b of the intake channel section 22. In a completely open position of the throttle element 24, the partition wall section 26 advantageously adjoins the throttle element 24 over at least 60%, advantageously over at least 70%, preferably over at least 90% of the width b of the intake channel section 22.

The partition wall section 26 is preferably configured in one piece with the base body 21 of the fuel supply device 20. The partition wall section 26 preferably consists of metal. In particular, the partition wall section 26 is a cast metal part.

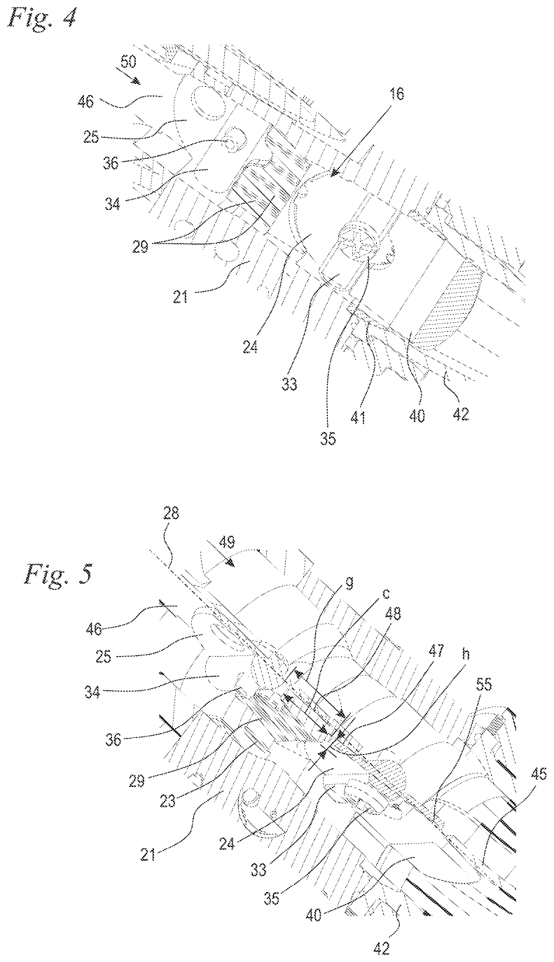

As FIG. 3 also shows, the ribs 29 preferably widen in the direction of the flow direction 50. The configuration of the ribs 29 is also shown in detail in FIG. 4.

As FIG. 5 shows, the ribs 29 have a length c. The length c is preferably from 70% to 100% of a spacing g between the throttle element 24 and the choke shaft 34, which spacing g is measured in a completely open position of the throttle element 24. Here, the length c and the spacing g are measured parallel to the longitudinal center axis 28.

As FIG. 5 shows, the height h of the partition wall section 26 is advantageously dimensioned in such a way that, in the viewing direction of the arrow 49, the partition wall section 26 lies completely behind the choke shaft 34 and the fastening element 36 for the choke element 25.

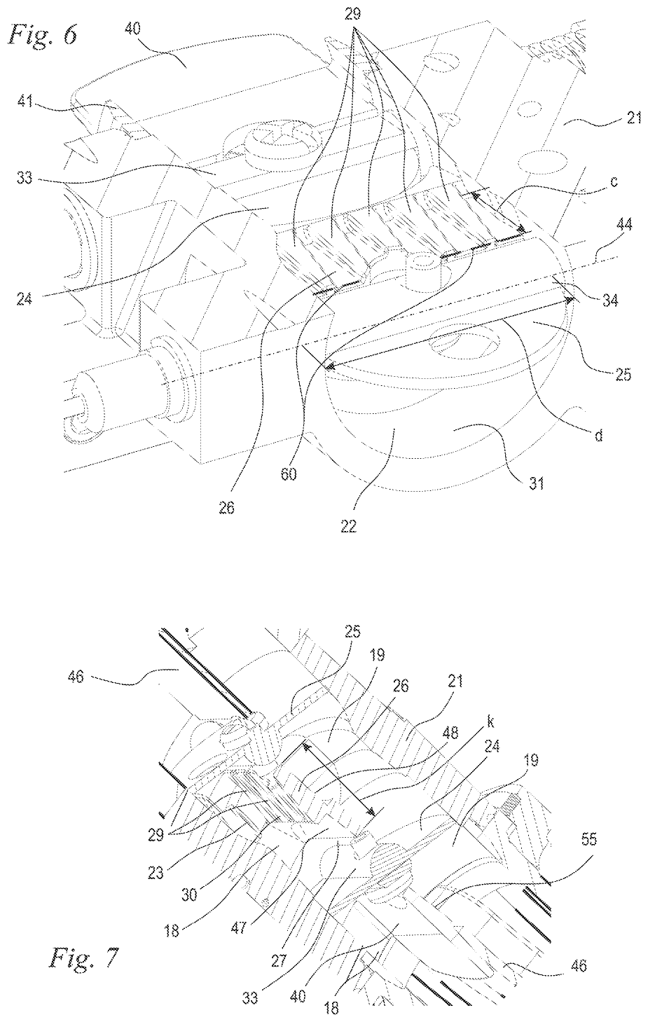

As FIG. 6 shows, five ribs 29 are provided in the embodiment. The length c of the ribs 29 is smaller than a diameter d of the intake channel section 22. Here, the diameter d of the intake channel section 22 is measured on a central axis 44 of the choke shaft 34. The partition wall section 26 upstream of the throttle shaft 33 has a length which corresponds in the embodiment to the length c of the ribs 29. The length k of the partition wall section 26 (FIG. 7) is preferably at least 0.5 times the diameter d of the intake channel section 26 on the choke shaft 34.

As FIG. 7 shows, the partition wall section 26 has a first recess 47 on the side which faces the mixture channel 18. On the opposite side, the partition wall section 26 has a second recess 48. As FIG. 5 shows, the throttle element 24 lies in the first recess 47 in the completely open position. The choke element 25 lies in the second recess 48 in a completely open position. In the full throttle position, the choke element 25 and the throttle element 24 advantageously lie completely in the associated recess 47 and 48 and do not protrude beyond the outer side of the partition wall section 26. As FIG. 7 shows, the partition wall section 40 has a third recess 55, in which the throttle element 24 bears in a completely open position (FIG. 5). The bottom of the third recess 55 is of beveled configuration, which results in a flat contact of the throttle element 24.

As FIG. 7 shows, there is a slight spacing between the partition wall section 26 and the throttle shaft 33 in a completely open position of the throttle element 24. As a result, an opening 27 is formed in the partition wall 17. During idling and at low partial load when the throttle element 24 is largely or completely closed, fuel can transfer as a result from the mixture channel 18 into the air channel 19. As a result, excessive starvation during idling and at a low partial load is prevented.

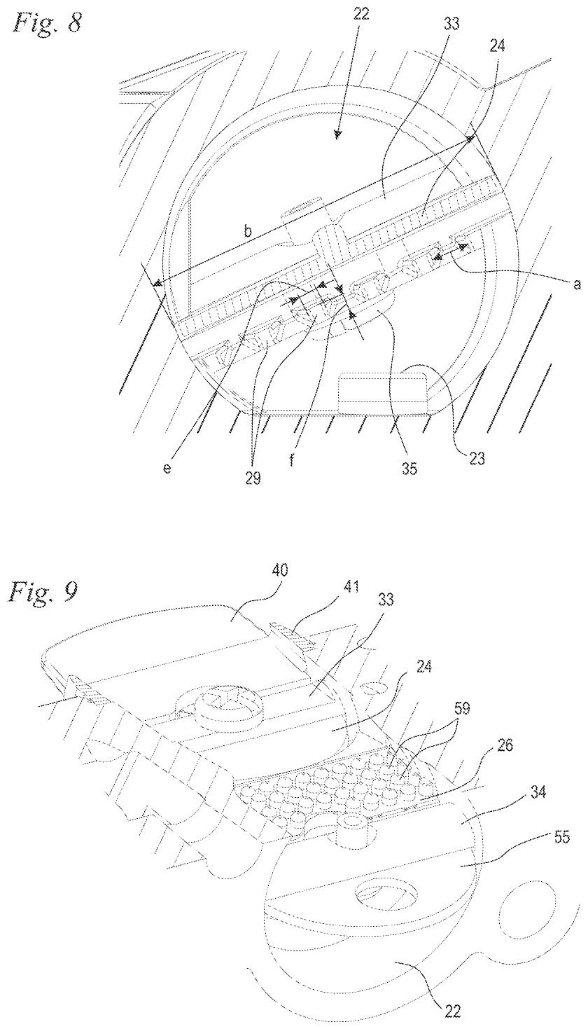

FIG. 8 shows the configuration of the ribs 29 in detail. The ribs 29 have a width e which is measured in the transverse direction of the intake channel section 22, and a height f which is measured perpendicularly with respect to the width e and perpendicularly with respect to the surface of the partition wall section 26. Adjacent ribs 29 are at a spacing a from one another. The width e and the spacing a are measured parallel to the central axis 44 of the choke shaft 34 (FIG. 6) and parallel to a central axis 43 of the throttle shaft 33. The height f is measured perpendicularly with respect to the central axes 43 and 44 and perpendicularly with respect to the longitudinal center axis 28. The central axes 43 and 44 are also shown in FIG. 3. The width b of the ribs 29 increases in the flow direction 50, as FIG. 3 also shows, in particular. As a result, the spacing a between adjacent ribs 29 decreases in the flow direction 50. In the embodiment, the height h of the ribs 29 also increases in the flow direction 50. As a result, a streamlined shape for the Venturi section 30 can be achieved. At the same time, simple demolding of the base body 21 during the production of the base body with the partition wall section 26 integrally molded thereon and ribs 29 integrally molded thereon using metal casting is ensured.

On account of the ribs 29 in every cross section, the surface area of the intake channel 18 is increased in the respective cross section perpendicularly with respect to the longitudinal center axis 28 of the intake channel section 22 by way of the ribs 29 in comparison with a straight, planar course of the partition wall section 26, in particular by way of the thinnest point of the partition wall section 26 in this cross section. The straight, planar course of the partition wall section 26 is illustrated in FIG. 6 by way of dashed line 80 for a cross section through the downstream end side of the ribs 29.

The height h of the ribs 29 is preferably less than 20%, in particular less than 10% of the diameter d of the intake channel section 22 at the choke shaft 34. The spacing a between adjacent ribs 29 is preferably from 50% to 200% of the width e of a rib 29.

The fuel opening 23 is arranged so as to lie opposite the ribs 29 in the intake channel section 22. As FIG. 2 shows, in particular, the fuel opening 23 is arranged immediately downstream of the choke shaft 34. The fuel opening 23 is arranged adjacently with respect to the upstream (in the flow direction 50) side of the partition wall section 26. The partition wall section 26, on which the at least one element for increasing the surface area is arranged, is preferably closed in the circumferential direction. The partition wall section 26 is preferably configured in one piece with the base body 21. It can also be provided, however, that the partition wall section 26 is configured separately from the base body 21 and is fixed on the latter, in particular is pressed into the latter. Fuel which exits from the fuel opening 23 can be deposited directly on the partition wall section 26 and can evaporate here. On account of the elements for increasing the surface area, the fuel quantity which can be deposited is comparatively great. The cooling by evaporation which is produced by way of the evaporation cools the partition wall section 26 and the base body 21 which is configured in one piece with it.

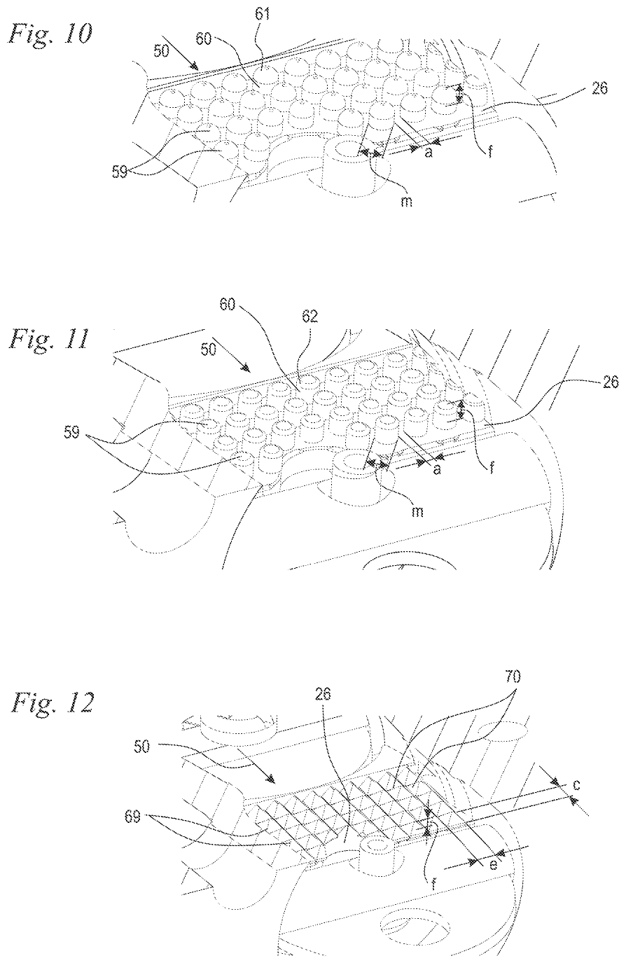

FIGS. 9 to 12 show further embodiments of elements for increasing the surface area. In the case of an embodiment according to FIGS. 9 and 10, bumps 59 are arranged on the partition wall section 26 in order to increase the surface area. In the embodiment, a multiplicity of bumps 59 are provided. As a result, a comparatively great increase in the surface area is achieved. In relation to the flow direction 50, the bumps 59 are arranged in a plurality of rows which lie next to one another. As FIG. 10 shows, bumps 59 which lie next to one another are at a spacing a from one another. Bumps 59 which lie behind one another in the flow direction 50 are advantageously at a spacing from one another which can correspond to the spacing a or can be greater or smaller than the spacing a. It can also be provided that the bumps 59 are not at a spacing from one another in the flow direction 50 and/or transversely with respect to the flow direction 50. In the embodiment, the bumps 59 have a height f which is measured to the center of the base area. The height f can be, for example, from 50% to 150% of the diameter m. A greater or smaller height f can also be advantageous.

The bumps 59 increase the circumferential length of the intake channel wall in the mixture channel 18 in comparison with a mixture channel 18, on the partition wall section 26 of which no bumps 59 are arranged and the surface of which is straight and planar at least on the side which faces the mixture channel 18 and runs through those sections of the surface of the partition wall section 26 which are arranged between the bumps 59.

Here, the circumferential length of the mixture channel 18 is increased in at least one cross section perpendicularly with respect to the flow direction 50. The circumferential length is advantageously increased in comparison with a straight, planar course of the partition wall section 26 in the respective cross section which runs through that region of the partition wall section 26 which has the smallest thickness and/or the smallest spacing from the air channel 19.

In the case of an embodiment according to FIG. 10, each bump 59 has a cylindrical section 60 which is arranged on the partition wall section 26. In the cylindrical section 60, the bumps 59 have a diameter m. This results in the same extent of the bumps 59 in the flow direction 50 and transversely with respect to the flow direction 50. Accordingly, the bumps 59 have the same length and width. The cylindrical section 60 is advantageously integrally formed on the partition wall section 26, and is configured in one piece with the latter. A dome 61 which can be, for example, of approximately hemispherical configuration is advantageously arranged on the cylindrical section 60. The dome 61 advantageously protrudes into the mixture channel 18.

FIG. 11 shows an alternative configuration of bumps 59. In the embodiment of FIG. 11, a beveled or rounded section 62 adjoins the cylindrical section 60. The beveled or rounded section 62 replaces the dome 61 of the embodiment according to FIG. 10. The spacing a between adjacent bumps 59, the height f of the bumps 59 and the diameter m of the bumps 59 can be selected as in the embodiment according to FIG. 10.

FIG. 12 shows a further embodiment, in the case of which pyramid-shaped elevations 69 are arranged on the partition wall section 26. The elevations 69 are arranged so as to adjoin one another directly both in the flow direction 50 and transversely with respect to the flow direction 50, which results in a spacing a between adjacent pyramid-shaped elevations 69 neither in the flow direction nor transversely with respect to the flow direction. In an alternative configuration, a spacing between adjacent pyramid-shaped elevations 69 can be provided in the flow direction 50 and/or transversely with respect to the flow direction 50. In the embodiment, the pyramid-shaped elevations 69 have a rectangular base area, preferably a square base area, by way of which they are arranged on the partition wall section 26. The pyramid-shaped elevations 60 are configured, in particular, in one piece with the partition wall section 26. A different base area of the pyramid-shaped elevations 69 can also be advantageous, however.

The pyramid-shaped elevations 69 have a length c which is measured in the flow direction 50, and a width e which is measured transversely with respect to the flow direction 50. In the embodiment, the length c and the width e are of identical magnitude. The pyramid-shaped elevations 69 have a height f. The height f can be smaller than the length c and/or smaller than the width e. It can be provided that the height f is greater than the length c and/or is greater than the width i.

By way of their own oblique flanks, the pyramid-shaped elevations 69 form channels 70 which are oriented in the flow direction 50.

In all the embodiments, the width g is measured in the transverse direction of the intake channel section 22. In all the embodiments, the height f is measured perpendicularly with respect to the width e and perpendicularly with respect to the surface of the partition wall section 26. In all the embodiments, the spacing a is measured in the transverse direction of the intake channel section 22, that is, perpendicularly with respect to the flow direction 50.

The ribs 29, the bumps 59 and the pyramid-shaped elevations 69 increase the circumferential length of the intake channel section 22 in a section perpendicularly with respect to the flow direction 50 as a result of the ribs 29, bumps 59 or pyramid-shaped elevations 69 in comparison with the circumferential length of the intake channel section 23 in the case of a planar, straight course of the partition wall section 26 through that region of the partition wall section 26 which lies between adjacent ribs 29, bumps 59 or pyramid-shaped elevations 69. That region of the partition wall section 26 which lies between adjacent ribs 29, bumps 59 or pyramid-shaped elevations 69 advantageously corresponds to the region of the partition wall section 26 with the smallest thickness in this section. The at least one element for increasing the surface area advantageously rises up from a partition wall section 26 which has a straight, planar surface area on the side which faces the mixture channel 18.

It is understood that the foregoing description is that of the preferred embodiments of the invention and that various changes and modifications may be made thereto without departing from the spirit and scope of the invention as defined in the appended claims.

What is claimed is:

1. A fuel supply device comprising:
a base body defining an intake channel section therein;
an adjustable throttle element configured to control a free flow cross section of said intake channel section;
a fuel opening which opens into said intake channel section;
a partition wall section arranged in said intake channel section upstream of said throttle element;
said partition wall section and said throttle element dividing, in a completely open position of said throttle element, said intake channel section upstream of said throttle element into a mixture channel, into which said fuel opening opens for feeding fuel, and an air channel, wherein said throttle element bears against said partition wall section in the completely open position; and,
said partition wall section has an element for increasing a surface area within said mixture channel.

2. A fuel supply device comprising:
a base body defining an intake channel section therein;
at least one adjustable throttle element configured to control a free flow cross section of said intake channel section;
a fuel opening which opens into said intake channel section;
a partition wall section arranged in said intake channel section upstream of said throttle element;
said partition wall section and said throttle element dividing, in a completely open position of said throttle element, said intake channel section upstream of said throttle element into a mixture channel, into which said fuel opening opens for feeding fuel, and an air channel;
said partition wall section being configured in one piece with said base body; and,
said partition wall section having an element for increasing a surface area within said mixture channel.

3. The fuel supply device of claim 2, wherein said throttle element bears against said partition wall section in the completely open position.

4. The fuel supply device of claim 1, wherein said element for increasing the surface area is configured in one piece with said partition wall section.

5. The fuel supply device of claim 1, wherein said base body is made of aluminum or an aluminum alloy.

6. The fuel supply device of claim 1, wherein said intake channel section defines a width (b); and, said partition wall section adjoins said throttle element over at least 60% of said width (b) of said intake channel section in the completely open position of said throttle element.

7. The fuel supply device of claim 1, wherein said partition wall section and said throttle element define an opening between each other in at least one of a partially closed position of said throttle element and a completely closed position of said throttle element; and, said opening interconnects said air channel and said mixture channel.

8. The fuel supply device of claim 1, wherein said mixture channel defines a circumferential length; and, said element for increasing the surface area increases said circumferential length of said mixture channel in comparison with a mixture channel having a planar partition wall section which runs parallel to a longitudinal center axis of an intake channel section.

9. The fuel supply device of claim 1, wherein said element for increasing the surface area is oriented in a longitudinal direction of said intake channel section.

10. The fuel supply device of claim 1, wherein a plurality of said elements for increasing the surface area are provided; and, said plurality of said elements are arranged in a transverse direction of said intake channel section at a spacing (a) from one another on said partition wall section.

11. The fuel supply device of claim 1, wherein said element for increasing the surface area is a rib, a bump, or a pyramid-shaped elevation.

12. The fuel supply device of claim 1, wherein said partition wall section is made from metal.

13. The fuel supply device of claim 1, wherein a Venturi section is formed in said mixture channel on said partition wall section.

14. The fuel supply device of claim 13, wherein said Venturi section is formed by way of said element for increasing the surface area.

15. The fuel supply device of claim 14, wherein said element for increasing the surface area is a rib, a bump, or a pyramid-shaped elevation.

16. The fuel supply device of claim 1 further comprising:
an adjustable choke element arranged in said intake channel section upstream of said throttle element;
said adjustable choke element having a choke shaft;
said adjustable throttle element having a throttle shaft; and,
said partition wall section being arranged in a flow direction between said choke shaft and said throttle shaft.

17. The fuel supply device of claim 16, wherein said choke element bears against said partition wall section in the completely open position.

18. The fuel supply device of claim 16 further comprising:
a fastening element for fastening said choke element to said choke shaft; and,
wherein said element for increasing the surface area is covered completely by said choke shaft and said fastening element when said choke element is completely open and when viewed in a viewing direction in a direction of a longitudinal center axis from said choke element to said throttle element.

19. The fuel supply device of claim 16 further comprising:
a fastening element for fastening said choke element to said choke shaft;
said partition wall section having a plurality of said elements for increasing a surface area within said mixture channel; and,
wherein all of said plurality of said elements for increasing the surface area are covered completely by said choke shaft and said fastening element when said choke element is completely open and when viewed in a viewing direction in a direction of a longitudinal center axis from said choke element to said throttle element.

20. The fuel supply device of claim 16, wherein:
said intake channel section defines a longitudinal center axis; and,
a length (c), measured in a direction of the longitudinal center axis of said intake channel section, of said element for increasing the surface area corresponds to 70% to 100% of a spacing (d) of said throttle element from said choke shaft at this point in a case of the completely open throttle element.
